(19) United States
(12) Patent Application Publication
(10) Pub. No.: US 2024/0406859 A1
(43) Pub. Date: Dec. 5, 2024

(54) CPAC EVALUATION METHOD, PROCESSING METHOD FOR CPAC CONFIGURATION, AND DEVICE

(71) Applicant: VIVO MOBILE COMMUNICATION CO., LTD., Dongguan (CN)

(72) Inventors: Jing LIANG, Dongguan (CN); Wei BAO, Dongguan (CN)

(73) Assignee: VIVO MOBILE COMMUNICATION CO., LTD., Dongguan (CN)

(21) Appl. No.: 18/806,662

(22) Filed: Aug. 15, 2024

Related U.S. Application Data
(63) Continuation of application No. PCT/CN2023/075853, filed on Feb. 14, 2023.

(30) Foreign Application Priority Data
Feb. 18, 2022 (CN) 202210151726.X

(51) Int. Cl. H04W 48/20; H04W 48/16

(52) U.S. Cl. CPC H04W 48/20; H04W 48/16

(57) ABSTRACT

A Conditional Primary Secondary Cell Addition or Change (CAP) evaluation method, a processing method for CPAC configuration, and a device, are provided. The CPAC evaluation method includes: performing, by a terminal, CPAC; and skipping releasing, by the terminal, a CPAC configuration after the completion of CPAC, and continuing CPAC evaluation.

### CROSS-REFERENCE TO RELATED APPLICATIONS

The application is a continuation of International Application No. PCT/CN2023/075853, filed on Feb. 14, 2023, which claims priority to Chinese Patent Application No. 202210151726.X, filed Feb. 18, 2022. The entire contents of each of the above-identified applications are expressly incorporated herein by reference.

### TECHNICAL FIELD

This application pertains to the field of communications technologies, and specifically, relates to a Conditional PSCell Addition or Change (CPAC) evaluation method, a processing method for CPAC configuration, and a device.

### BACKGROUND

In the related art, a terminal needs to release a stored CPAC configuration after completing CPAC. If the CPAC needs to be continued later, a network-side device needs to make a configuration again, resulting in unnecessary signaling burden.

### SUMMARY

Embodiments of this application provide a CPAC evaluation method, a processing method for CPAC configuration, and a device.

According to a first aspect, a CPAC evaluation method is provided, including: performing, by a terminal, CPAC; and skipping releasing, by the terminal, the CPAC configuration after the completion of CPAC, and continuing CPAC evaluation.

According to a second aspect, a processing method for CPAC configuration is provided, including: performing, by a terminal, at least one of the following: in a case that an SCG RLF occurs on the terminal, releasing, by the terminal, a CPAC configuration; in a case that the terminal performs a reconstruction process and the reconstruction process is successful, retaining, by the terminal, the CPAC configuration; in a case that the terminal performs a reconstruction process and the reconstruction process fails, releasing, by the terminal, the CPAC configuration; and in a case that CPAC performed by the terminal fails, skipping releasing, by the terminal, the CPAC configuration within a first time period, and continuing CPAC evaluation.

According to a third aspect, a CPAC evaluation method is provided, including: sending, by a network-side device, a CPAC configuration, where the CPAC configuration meets at least one of the following: the CPAC configuration is associated with a cell identifier of a PScell, the cell identifier being used to indicate whether the terminal is to continue CPAC evaluation after completion of CPAC; the CPAC configuration includes a plurality of measurement events, the plurality of measurement events being used to indicate the terminal not to release the CPAC configuration after the completion of CPAC and to continue CPAC evaluation; and the CPAC configuration includes a plurality of parameters, the plurality of parameters being used to indicate the terminal not to release the CPAC configuration after the completion of CPAC and to continue CPAC evaluation.

According to a fourth aspect, a CPAC evaluation apparatus is provided, including: a first processing module, configured to perform CPAC; and a second processing module, configured to skip releasing a CPAC configuration after the completion of CPAC, and continue CPAC evaluation.

According to a fifth aspect, a CPAC configuration processing apparatus is provided, including: a processing module configured to perform at least one of the following: in a case that an SCG RLF occurs on the apparatus, releasing a CPAC configuration; in a case that the apparatus performs a reconstruction process and the reconstruction process is successful, retaining the CPAC configuration; in a case that the apparatus performs a reconstruction process and the reconstruction process fails, releasing the CPAC configuration; and in a case that CPAC performed by the apparatus fails, skipping releasing the CPAC configuration within a first time period, and continuing CPAC evaluation.

According to a sixth aspect, a CPAC evaluation apparatus is provided, including: a sending module, configured to send a CPAC configuration, where the CPAC configuration meets at least one of the following: the CPAC configuration is associated with a cell identifier of a PScell, the cell identifier being used to indicate whether the terminal is to continue CPAC evaluation after completion of CPAC; the CPAC configuration includes a plurality of measurement events, the plurality of measurement events being used to indicate the terminal not to release the CPAC configuration after the completion of CPAC and to continue CPAC evaluation; and the CPAC configuration includes a plurality of parameters, the plurality of parameters being used to indicate the terminal not to release the CPAC configuration after the completion of CPAC and to continue CPAC evaluation.

According to a seventh aspect, a terminal is provided, where the terminal includes a processor and a memory, and a program or instructions capable of running on the processor are stored in the memory. When the program or the instructions are executed by the processor, the steps of the method according to the first aspect or the second aspect are implemented.

According to an eighth aspect, a terminal is provided, including a processor and a communication interface. The processor is configured to perform CPAC; and skip releasing a CPAC configuration after completion of CPAC, and continue CPAC evaluation; or the processor is configured to perform at least one of the following: release the CPAC configuration in a case that an SCG RLF occurs on the terminal; in a case that the terminal performs a reconstruction process and the reconstruction process is successful, retain the CPAC configuration; in a case that the terminal performs a reconstruction process and the reconstruction process fails, release the CPAC configuration; and in a case that CPAC performed by the terminal fails, skip releasing the CPAC configuration within a first time period and continue CPAC evaluation.

According to a ninth aspect, a network-side device is provided, where the network-side device includes a processor and a memory, and a program or instructions capable of running on the processor are stored in the memory. When the program or the instructions are executed by the processor, the steps of the method according to the third aspect are implemented.

According to a tenth aspect, a network-side device is provided, including a processor and a communication interface. The communication interface is configured to send a CPAC configuration, where the CPAC configuration meets at least one of the following: the CPAC configuration is associated with a cell identifier of a PScell, the cell identifier being used to indicate whether the terminal is to continue CPAC evaluation after completion of CPAC; the CPAC configuration includes a plurality of measurement events, the plurality of measurement events being used to indicate the terminal not to release the CPAC configuration after the completion of CPAC and to continue CPAC evaluation; and the CPAC configuration includes a plurality of parameters, the plurality of parameters being used to indicate the terminal not to release the CPAC configuration after the completion of CPAC and to continue CPAC evaluation.

According to an eleventh aspect, a CPAC evaluation system is provided, including: a terminal and a network-side device, where the terminal may be configured to perform the steps of the method according to the first aspect or the second aspect, and the network-side device may be configured to perform the steps of the method according to the third aspect.

According to a twelfth aspect, a readable storage medium is provided, where a program or instructions are stored in the readable storage medium, and when the program or the instructions are executed by a processor, the steps of the method according to the first aspect, the second aspect, or the third aspect are implemented.

According to a thirteenth aspect, a chip is provided, where the chip includes a processor and a communication interface, the communication interface is coupled to the processor, and the processor is configured to run a program or instructions to implement the method according to the first aspect, the second aspect, or the third aspect.

According to a fourteenth aspect, a computer program/program product is provided, where the computer program/program product is stored in a storage medium, and the computer program/program product is executed by at least one processor to implement the steps of the method according to the first aspect, the second aspect, or the third aspect.

### BRIEF DESCRIPTION OF DRAWINGS

FIG. 1 is a block diagram of a wireless communication system according to an embodiment of this application;

FIG. 2 is a flowchart of a CPAC evaluation method according to an embodiment of this application;

FIG. 3 is a flowchart of a processing method for CPAC configuration according to an embodiment of this application;

FIG. 4 is a flowchart of a CPAC evaluation method according to an embodiment of this application;

FIG. 5 is a block diagram of a CPAC evaluation apparatus according to an embodiment of this application;

FIG. 6 is a flowchart of a processing method for CPAC configuration according to an embodiment of this application;

FIG. 7 is a block diagram of a CPAC evaluation apparatus according to an embodiment of this application;

FIG. 8 is a block diagram of a communication device according to an embodiment of this application;

FIG. 9 is a block diagram of a terminal according to an embodiment of this application; and

FIG. 10 is a block diagram of a network-side device according to an embodiment of this application.

### DETAILED DESCRIPTION

The following describes the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

In the specification and claims of this application, the terms such as “first” and “second” are intended to distinguish between similar objects but do not necessarily indicate a specific order or sequence. It should be understood that the data used in this way is interchangeable in appropriate circumstances so that the embodiments of this application can be implemented in other orders than the order illustrated or described herein, and “first” and “second” are usually for distinguishing same-type objects but not limiting the number of objects, for example, there may be one or more first objects. In addition, “and/or” in this specification and claims indicates at least one of connected objects, and the symbol “/” generally indicates that the associated objects are in an “or” relationship.

It should be noted that techniques described in the embodiments of this application are not limited to a Long Term Evolution (LTE) or LTE-Advanced (LTE-A) system, and may also be applied to various wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and other systems. The terms “system” and “network” in the embodiments of this application are usually used interchangeably. Techniques described herein may be used in the aforementioned systems and radio technologies, and may also be used in other systems and radio technologies. In the following descriptions, a New Radio (NR) system is described for an illustration purpose, and NR terms are used in most of the following descriptions, although these technologies may also be applied to other applications than an NR system application, for example, the 6th Generation (6G) communication system.

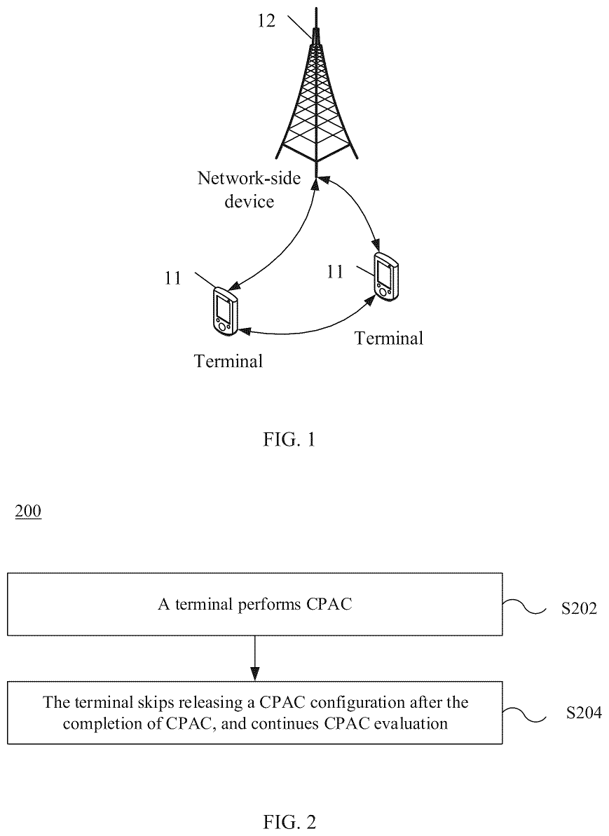

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with wireless communication function, such as a refrigerator, a television, a washing machine, or a furniture), a game console, a personal computer, a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, and the like. It should be noted that a specific type of the terminal 11 is not limited in the embodiments of this application. The network-side device 12 may include an access network device or a core network device, where the access network device may also be referred to as a radio access network device, a Radio Access Network (RAN), a radio access network function, or a radio access network unit. The access network device may include a base station, a Wireless Local Area Network (WLAN) access point, a Wireless Fidelity (WiFi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

The following describes in detail a Conditional Primary Secondary Cell Addition or Change (Conditional PSCell Addition or Change, CPAC) evaluation method and a processing method for CPAC configuration provided in the embodiments of this application by using some embodiments and application scenarios thereof with reference to the accompanying drawings. As shown in FIG. 2, an embodiment of this application provides a CPAC evaluation method 200. The method may be executed by a terminal. In other words, the method may be executed by software or hardware installed in the terminal. The method includes the following steps.

S202: The terminal performs CPAC.

S204: The terminal skips releasing a CPAC configuration after the completion of CPAC, and continues CPAC evaluation.

In some implementations, the CPAC includes Conditional PSCell Addition (CPA) and/or Conditional PSCell Change (CPC), and S204 may include at least one of the following:
(1) The terminal skips releasing the CPAC configuration after completion of CPA, and continues CPA evaluation, where the CPAC configuration may be a CPA configuration.
(2) The terminal skips releasing the CPAC configuration after completion of CPA, and continues CPC evaluation, where the CPAC configuration may be a CPC configuration. In this embodiment, a network-side device may configure both a CPA configuration and a CPC configuration for the terminal, and indicate that a candidate cell can be used for CPA or CPC.
(3) The terminal skips releasing the CPAC configuration after completion of CPC, and continues CPC evaluation, where the CPAC configuration may be a CPC configuration.
(4) The terminal skips releasing the CPAC configuration after completion of CPC, and continues CPA evaluation, where the CPAC configuration may be a CPA configuration. In this embodiment, the network-side device may configure both the CPA configuration and the CPC configuration for the terminal, and indicate that a candidate cell can be used for CPA or CPC.

In the CPAC evaluation method provided in this embodiment of this application, the terminal may skip releasing the CPAC configuration after the completion of CPAC, and continue CPAC evaluation, which can reduce signaling required for the CPAC configuration, thereby reducing signaling overheads between the network-side device and the terminal.

In some implementations, that the terminal skips releasing the CPAC configuration after the completion of CPAC, and continues CPAC evaluation includes: in a case that at least one of the following (1) to (12) is met, the terminal skips releasing the CPAC configuration after the completion of CPAC, and continues CPAC evaluation:
(1) The CPAC configuration is configured by a Master Node (MN). Because the master node usually does not change, the CPAC configuration may be configured by the master node for the terminal and is used to perform continuous CPAC.
(2) The terminal and/or the network-side device operates on a target band. The target band includes, for example, a millimeter-wave band (Frequency range 2, FR2), and generally, a higher operating band indicates a higher frequency of CPAC execution.
(3) The terminal and/or the network-side device performs communication using a beam (beam).
(4) The number of times of CPAC performed by the terminal within a preset time period meets a first preset condition. For example, the number of times of CPAC performed by the terminal within a preset time period exceeds a specific threshold.
(5) The number of times of CPAC performed by the terminal meets a second preset condition. For example, the number of times of CPAC performed by the terminal exceeds a specific threshold, and for another example, an interval between two CPACs of the terminal is less than a specific threshold.
(6) The terminal supports being configured with a plurality of Secondary Cell Group (SCG) and/or Primary Secondary Cell (PScell).
(7) The network-side device indicates allowing the terminal to perform continuous CPAC. The network-side device may explicitly indicate allowing the terminal to perform continuous CPAC, or may implicitly indicate allowing the terminal to perform continuous CPAC.
(8) The terminal has not received a new CPAC configuration. For example, if the terminal has not received a new CPA configuration after the completion of CPA, the terminal may skip releasing the CPA configuration and continues CPA evaluation.
(9) A first timer has not expired, the first timer being used for indicating whether the terminal is to release the CPAC configuration. For example, if the first timer has not expired, the terminal may skip releasing the CPAC configuration; or if the first timer expires, the terminal may release the CPAC configuration.
(10) A count value of a first counter does not exceed a first threshold, the first counter being used for indicating whether the terminal is to release the CPAC configuration. For example, if the count value of the first counter does not exceed the first threshold, the terminal may skip releasing the CPAC configuration; or if the count value of the first counter reaches the first threshold, the terminal may release the CPAC configuration.

In this embodiment, the method further includes: performing an operation of adding 1 to the count value of the first counter in a case that at least one of the following is met: (a) CPAC is performed for one time; (b) CPAC is performed for one time and is successful; and (c) CPAC is performed for one time and fails.
(11) After completion of the CPAC, cell identifiers of one or more added or changed PScells are equal to a first identifier.

In this embodiment, CPAC configuration signaling sent by the network-side device to the terminal includes an indication field of “cell identifier of PScell”, where the indication field may be optional or mandatory.
(12) The terminal has switched a primary cell (PCell), and a cell identifier of a switched-to PCell is equal to a second identifier.

In this embodiment, CPAC configuration signaling sent by the network-side device to the terminal includes an indication field of “cell identifier of PScell”, where the indication field may be optional or mandatory.

In an example, the network-side device may explicitly indicate allowing the terminal to perform continuous CPAC. In a case that the network-side device indicates allowing the terminal to perform continuous CPAC, the method further includes: receiving, by the terminal, first indication information, where the first indication information is used to indicate at least one of the following:
(a) the terminal being allowed to perform continuous CPAC;
(b) the number of times of CPAC;
(c) duration of CPAC; and
(d) an execution threshold, the execution threshold being used to indicate whether the terminal is to perform continuous CPAC.

In an example, the network-side device may implicitly indicate allowing the terminal to perform continuous CPAC. That the network-side device indicates allowing the terminal to perform continuous CPAC includes: allowing the terminal to perform continuous CPAC in a case that at least one of the following is met:
(a) a first PSCell configuration is associated with one or more measurement events;
(b) the CPAC configuration includes a parameter of the first timer, the first timer being used for indicating whether the terminal is to release the CPAC configuration; where for example, if the count value of the first counter does not exceed the first threshold, the terminal may skip releasing the CPAC configuration; or if the count value of the first counter reaches the first threshold, the terminal may release the CPAC configuration; and
(c) the CPAC configuration includes a parameter of the first counter, the first counter being used for indicating whether the terminal is to release the CPAC configuration; where for example, if the count value of the first counter does not exceed the first threshold, the terminal may skip releasing the CPAC configuration; or if the count value of the first counter reaches the first threshold, the terminal may release the CPAC configuration.

The measurement event may include at least one of the following: an A4 measurement event, a B1 measurement event, an A3 measurement event, an A5 measurement event, and a predefined measurement event for continuous CPAC. For detailed content of the A4 measurement event, B1 measurement event, A3 measurement event, and A5 measurement event, refer to descriptions in related technologies.

In an example, in a case that the first timer has not expired, the terminal skips releasing the CPAC configuration after the completion of CPAC and continues CPAC evaluation. A starting or restarting moment of the first timer is related to at least one of the following moments:
(a) a moment at which the CPAC configuration is received;
(b) a moment at which CPAC is performed for the first time or any one time;
(c) a moment at which CPAC is successfully completed for the first time or any one time; and
(d) a moment at which CPAC fails for the first time or any one time.

In the foregoing examples, the first timer may be configured based on one of the following granularities: per terminal, per PCell, per PSCell, and per Radio Resource Control (RRC) configuration message. The RRC configuration message may include CPAC configuration.

In an example, the first timer is configured based on the granularity of per PCell or per PSCell, and the starting or restarting moment of the first timer is related to at least one of the following moments:
(a) a moment at which the CPAC configuration corresponding to the PCell or the PSCell is received;
(b) a moment at which CPAC is performed for the PCell or the PSCell for the first time or any one time;
(c) a moment at which CPAC for the PCell or the PSCell is completed for the first time or each time; and
(d) a moment at which CPAC for the PCell or the PSCell fails for the first time or any one time.

In the foregoing embodiments, a CPAC configuration has been configured for the terminal, and the method further includes at least one of the following:
(1) the terminal releases the CPAC configuration in a case that an SCG Radio Link Failure (RLF) occurs on the terminal;
(2) in a case that the terminal performs a reconstruction process and the reconstruction process is successful, the terminal continues to retain the CPAC configuration;
(3) in a case that the terminal performs a reconstruction process and the reconstruction process fails, the terminal releases the CPAC configuration; and
(4) in a case that CPAC performed by the terminal fails, the terminal skips releasing the CPAC configuration within a first time period and continues CPAC evaluation; or the terminal temporarily skips releasing the CPAC configuration and continues CPAC evaluation.

In this embodiment, in a case that the terminal performs a reconstruction process, the method further includes: if the terminal is restored to a previous first SCG cell, skipping releasing the CPAC configuration, and continuing CPAC evaluation; or if the terminal is restored to a new cell other than the first SCG cell or a new cell outside a preset range, releasing the CPAC configuration.

In this embodiment, in a case that CPAC performed by the terminal fails, the method further includes: sending, by the terminal, CPAC failure information, where the CPAC failure information includes at least one of the following: identification information of a failed PSCell; and the number of CPAC attempts or failures.

In some implementations, the method in the foregoing embodiments further includes: in a case that a key of the MN is changed, releasing, by the terminal, all CPAC configurations.

In some implementations, in the foregoing embodiments, in a case that the terminal releases the CPAC configuration, the CPAC configuration released by the terminal includes at least one of the following:
(1) all CPAC configurations configured for the terminal;
(2) a specific PCell-related CPAC configuration;
(3) a specific PSCell-related CPAC configuration;
(4) a CPAC configuration configured by a Secondary Node (SN); and
(5) a CPAC configuration determined by the SN and forwarded by the MN to the terminal.

In order to describe in detail the CPAC evaluation method provided in the embodiments of this application, the following provides descriptions with reference to several specific cases.

Case 1: The terminal continues CPA evaluation after the completion of CPA.

In this embodiment, the network-side device (such as a base station) configures a CPA configuration for a terminal (User Equipment, UE).

In a case that at least one of the following conditions (1) to (10) is met, the UE may skip releasing the CPA configuration after completing CPA for one time or completing an ordinary primary secondary cell addition (PSCell addition), and continues CPA evaluation after a current SCG is released. In some implementations, the CPA configuration may not be released after the CPA is completed for one time, or CPA evaluation may be continued when a current SCG is not released. This case is applicable to that the UE may add a plurality of SCGs at the same time.
(1) The CPA configuration is configured by the MN for the UE.
(2) The UE or base station operates on an FR2 band or performs communication using a beam (beam).
(3) The UE has performed frequent CPAC procedures. In this embodiment, the definition of frequent CPAC procedures is specified by the protocol or configured by the network side. For example, the number of CPACs within a first time exceeds a first count, or an interval between two CPACs is less than a second time.
(4) The current UE capability supports being configured with a plurality of SCGs (or PScells).
(5) The base station indicates allowing the UE to perform continuous CPA procedures.

Permission may be explicitly indicated, for example, by using one bit, and in some implementations, the number of times of CPA or duration of CPA may be further indicated.

In some implementations, the indication is configured for the UE by the MN in RRC reconfiguration (RRCReconfiguration), or indicated to the UE using SRB3 through the SN. Whether the indication is included can be determined by the MN, a source secondary node (SN), a target SN, or the like.

It can be implicitly indicated that, for a specific PSCell, if the configuration is associated with one or several measurement events, it means that the PSCell may continue to be evaluated as a candidate cell for CPA after CPA. In some implementations, the measurement event is at least one of A4, B1, A3, and A5.

In some implementations, the first timer or the first counter can alternatively be used as an implicit configuration method. For example, if one CPAC configuration includes a parameter of the first timer or the first counter, it means that the corresponding CPAC configuration may not be deleted after addition of the PSCell.
(6) No new CPA configuration or CPC configuration has been received from the base station.
(7) The first timer used by the UE for determining when to release the CPA configuration has not expired, where the UE needs to release the CPA and/or CPC configuration after the first timer expires.

In this embodiment, the UE may alternatively receive a related parameter of the first timer for the CPA configuration sent by the network side.

The starting or restarting moment of the first timer may be any one of the following: after the CPAC configuration from the network side is received; when CPA is performed for the first time or any one time; and when CPA is completed for the first time or any one time.

The first timer may be per UE, per PCell, or per PSCell.

In a case that the first timer is configured on a per-PCell or per-PSCell basis, in some implementations, the starting or restarting moment of the first timer may be one of the following: upon reception of a CPAC configuration corresponding to the PCell or PSCell; upon execution of CPAC for the first time or each time for the PCell or PSCell; upon completion of a CPAC procedure for the first time or each time for the PCell or PSCell; and upon an execution failure of a CPAC procedure for the first time or each time for the PCell or PSCell.

If the first timer expires, for the released CPAC configuration, all CPAC configurations of the UE may be released or only a specified PCell or PSCell-related CPAC configuration is released.

The first timer may alternatively be per RRC configuration message. That is, the target cell generates one PSCell change or addition reconfiguration message, where the reconfiguration message is valid only for a specific time (such as 1 minute).
(8) The first counter used by the UE for determining when to release the CPA configuration does not exceed a first threshold, and the first counter is used to count the number of times of CPA performed by the UE.

Further, an increment condition for the first counter may be one of the following: CPA is performed for one time; CPA is performed for one time and is successful; and CPA is performed for one time and fails.
(9) After the UE completes the CPA, one or more PScells currently added meet a condition, where the met condition means that CPA evaluation can be continued in a case that a cell identifier of the added PScell is N1.

In some implementations, in the CPA configuration corresponding to the network side, each CPA configuration includes or is associated with the cell identifier of the PScell. The cell identifier may be an NR Cell Identifier (NCI), an NR Cell Global Identifier (NCGI), a Physical Cell Identifier (PCI), or another cell identifier.
(10) When the UE switches a PCell, if a cell ID of a switched-to PCell is N2, CPA evaluation can be continued.

In some implementations, in the CPA configuration corresponding to the network side, each CPA configuration includes or is associated with the cell identifier of the PCell. The cell identifier may be an NCI, an NCGI, a PCI, or another cell identifier.

Case 2: The terminal continues CPC evaluation after the completion of CPA.

In this embodiment, the network-side device (such as a base station) configures a CPA configuration and a CPC configuration for the terminal (UE). In some implementations, one indication manner is to indicate that the candidate cell can be used for both CPA and CPC.

In a case that at least one of the following conditions (1) to (9) is met, after completing CPA for one time or completing an ordinary primary secondary cell addition, the UE continues CPC evaluation based on the CPC configuration.
(1) The CPA configuration is configured by the MN for the UE.
(2) The UE or base station operates on an FR2 band or performs communication using a beam.
(3) The UE has performed frequent CPAC procedures. For example, the number of times of CPAC in a specific time exceeds a specific value.
(4) The base station indicates allowing the UE to perform CPC for one or more times after CPA.

Permission may be explicitly indicated, for example, by using one bit, and in some implementations, the number of times of CPC or duration of CPC may be further indicated.

It can be implicitly indicated that, for a specific PSCell, if the configuration is associated with one or several measurement events, it means that the PSCell can continue to be evaluated as a candidate cell for CPC after CPA. In some implementations, the measurement event is at least one of A4, B1, A3, and A5.

In some implementations, the indication is configured for the UE by the MN in RRCReconfiguration, or indicated to the UE using SRB3 through the SN. Whether the indication is included can be determined by the MN, a source secondary node (SN), a target SN, or the like.
(5) No new CPA configuration or CPC configuration has been received from the base station.
(6) The first timer used by the UE for determining when to release the CPC configuration has not expired, where the UE needs to release the CPA and/or CPC configuration after the first timer expires.

The starting or restarting moment of the first timer may be any one of the following: after the CPAC configuration from the network side is received; when CPA is performed; when CPA is completed; when CPC is performed for the first time or any one time; and when CPC is completed for the first time or any one time.

The first timer may be per UE, per PCell, or per PSCell.

If the first timer expires, for the released CPAC configuration, all CPAC configurations of the UE may be released or only a specified PCell or PSCell-related CPAC configuration is released.
(7) The first counter used by the UE for determining when to release the CPC configuration does not exceed a first threshold, and the first counter is used to count the number of times of CPC or the number of times of CPA+CPC performed by the UE.
(8) After the UE completes the CPA, one or more PScells currently added meet a condition, where the met condition means that the configuration may not be released and CPC evaluation may be continued when a cell identifier of the added PScell is N3.

In some implementations, in the CPAC configuration corresponding to the network side, each CPAC configuration includes or is associated with the cell identifier of the PScell. The cell identifier may be an NCI, an NCGI, a PCI, or another cell identifier.
(9) When the UE switches the PCell, if a cell ID of a switched-to PCell is N4, CPA and/or CPC evaluation can be continued.

In some implementations, in the CPA and/or CPC configuration corresponding to the network side, each CPA and/or CPC configuration includes or is associated with the cell identifier of the PCell. The cell identifier may be an NCI, an NCGI, a PCI, or another cell identifier.

Case 3: The terminal continues CPC evaluation after the completion of CPC.

In this embodiment, the network-side device (such as the base station) configures a CPC configuration for the terminal (UE).

In a case that at least one of the following conditions (1) to (9) is met, after completing CPC for one time or completing an ordinary primary secondary cell change, the UE continues CPC evaluation.
(1) The CPC configuration is configured by the MN for the UE.
(2) The UE or base station operates on an FR2 band or performs communication using a beam.
(3) The UE has performed frequent CPAC procedures. For example, the number of times of CPAC in a specific time exceeds a specific value.
(4) The base station indicates allowing the UE to perform CPC for one or more times after CPC.

Permission may be explicitly indicated, for example, by using one bit, and in some implementations, the number of times of CPC or duration of CPC may be further indicated.

It can be implicitly indicated that, for a specific PSCell, if the configuration is associated with one or several measurement events, it means that the PSCell can continue to be evaluated as a candidate cell for CPC after CPC. In some implementations, the measurement event is at least one of A4, B1, A3, and A5.

In some implementations, the indication is configured for the UE by the MN in RRC reconfiguration (RRCReconfiguration), or indicated to the UE using SRB3 through the SN. Whether the indication is included can be determined by the MN, a source secondary node (SN), a target SN, or the like.
(5) No new CPA configuration or CPC configuration has been received from the base station.
(6) The first timer used by the UE for determining when to release the CPC configuration has not expired, where the UE needs to release the CPA and/or CPC configuration after the first timer expires.

The starting or restarting moment of the first timer may be any one of the following: after the CPAC configuration from the network side is received; when CPC is performed for the first time or any one time; and when CPC is completed for the first time or any one time.

The first timer may be per UE, per PCell, or per PSCell.

If the first timer expires, for the released CPAC configuration, all CPAC configurations of the UE may be released or only a specified PCell or PSCell-related CPAC configuration is released.

The first timer may alternatively be per RRC configuration message. That is, the target cell generates one PSCell change or addition reconfiguration message, where the reconfiguration message is valid only for a specific time (such as 1 minute).
(7) The first counter used by the UE for determining when to release the CPC configuration does not exceed a first threshold, and the first counter is used to count the number of times of CPC performed by the UE.
(8) After the UE completes the CPC, one or more PScells currently changed meet a condition, where the met condition means that CPC evaluation can be continued when a cell identifier of the added PScell is N5.

In some implementations, in the CPAC configuration corresponding to the network side, each CPAC configuration includes or is associated with the cell identifier of the PScell. The cell identifier may be an NCI, an NCGI, a PCI, or another cell identifier.
(9) When the UE switches a PCell, if a cell ID of a switched-to PCell is N6, CPA and/or CPC evaluation can be continued.

In some implementations, in the CPA and/or CPC configuration corresponding to the network side, each CPA and/or CPC configuration includes or is associated with the cell identifier of the PCell. The cell identifier may be an NCI, an NCGI, a PCI, or another cell identifier.

For the embodiment in which the terminal continues CPA evaluation after completion of CPC, refer to the description of case 3. Details are not repeated herein.

In the above embodiments, when the UE needs to release the CPAC configuration, at least one of the following may be released:
(1) all CPAC configurations of the UE;
(2) a specific PCell-related CPAC configuration, for example, PCell ID=X;
(3) a specific PSCell-related CPAC configuration, for example, PSCell ID=Y;
(4) a CPAC configuration configured by the SN; and
(5) a CPAC configuration determined by the SN and forwarded by the MN to the UE.

In the above embodiments, once the key of the MN is changed, the UE may release all CPAC configurations.

Before execution of the embodiments of the application, the network-side device may send a CPAC configuration to the terminal, and the CPAC configuration meets at least one of the following:
1. In the CPAC configuration sent to the terminal by the network-side device, each CPAC configuration includes or is associated with a cell identifier of a PScell, which is used for determining by the terminal whether one or more PScells currently added or changed after completion of the CPAC meet a condition. For example, when the cell identifier of the PSCell is N, the CPAC configuration may not be released and CPAC evaluation continues.
2. The CPAC configuration provided by the network-side device to the terminal may include a plurality of evaluation events, which is used for CPAC evaluation by the terminal. The network-side device may configure a plurality of measurement events for each of different PSCells; or configure a plurality of measurement events and different parameters such as execution thresholds for one PSCell.
3. The CPAC configuration provided by the network-side device to the terminal may include different parameters, so that the terminal continues CPAC evaluation based on a new parameter after completion of each CPAC execution.

The following describes a release procedure of the CPAC configuration in different failure cases.

When at least one of the following conditions is met, the UE performs release or reservation of the CPAC configuration:
(1) After an SCG RLF occurs on the UE, the CPAC configuration is released.
(2) When the UE performs a reconstruction process (for example, after an SCG RLF occurs on the UE), determining is made based on a reconstruction result: if reconstruction is successful subsequently, the CPAC configuration is still retained and the CPAC configuration may not be released; and if reconstruction fails, the CPAC configuration is released.

Further, if the UE is restored to a previous SCG cell, the CPAC configuration may not be released; and if the UE is restored to a new cell or a new cell outside a specific range, the CPAC configuration is released. The range may be configured by the base station, such as a cell identifier list or a specific geographical area range.
(3) When the UE fails in a CPA or CPC procedure, the CPAC configuration is not released temporarily and evaluation continues. In some implementations, after the UE successfully performs CPAC for one time subsequently, the CPAC configuration is released.

Further, when the UE fails in the CPA or CPC procedure, identification information of the failed PSCell and the number of CPAC attempts or failures can be notified to the base station in the failure information.

In order to describe in detail the CPAC evaluation method provided in the embodiments of this application, the following provides descriptions with reference to several specific embodiments.

### Embodiment 1

This embodiment includes the following steps:

Step 1: The MN configures a CPA configuration and a CPC configuration for the UE, and indicates that UE can continue CPC evaluation after CPA.

The indication may be included in conditional reconfiguration (ConditionalReconfiguration), for example, being included in CondReconfigToAddMod-r18.

The CPA configuration includes a plurality of candidate PSCells, corresponding measurement events and thresholds, and the like.

The CPC configuration includes a plurality of candidate PSCells, corresponding measurement events and thresholds, and the like, where the identifier indicates a current PSCell being which specific one.

Step 2: The UE detects that a candidate PSCell 1 for CPA meets a condition, the UE performs CPA and adds the PSCell 1. In this case, the UE releases a CPA configuration and continues CPC evaluation based on a CPC configuration associated with PSCell 1.

Step 3: The UE detects that a candidate PSCell 2 for CPC meets a condition, the UE performs CPC and changes the PSCell from the PSCell 1 to the PSCell 2.

### Embodiment 2

This embodiment includes the following steps:

Step 1: The MN configures a CPC configuration for the UE.

The CPC configuration includes a plurality of candidate PSCells, corresponding measurement events and thresholds, and the like. An event associated with a PSCell 1 is A3, an event associated with a PSCell 2 is A4 or B1, and an event associated with PSCell 3 is A5.

Step 2: The UE detects that a candidate PSCell 1 for CPC meets a condition, the UE performs CPC and changes the current PSCell to PSCell 1. In this case, the UE releases a CPC configuration related to a PSCell 3 with the associated event A5, and continues CPC evaluation based on a configuration of the PSCell 2 with an associated event A4.

Step 3: The UE detects that a candidate PSCell 2 for CPC meets a condition, the UE performs CPC and changes the PSCell from the PSCell 1 to the PSCell 2.

### Embodiment 3

This embodiment mainly describes a configuration method for execution conditions, which is described in the following cases 1 and 2.

Case 1: The CPAC configuration provided by the network side to the UE includes a measurement threshold 1, a measurement threshold 2, and a measurement threshold 3.

In a case that the UE does not perform CPAC, the measurement threshold 1 is used for determining when the UE is to perform CPAC. Once CPAC is performed for one time, subsequent CPAC evaluation is performed by using a new measurement threshold.

Case 2: In the CPAC configuration provided by the network side to the UE, the PSCell 1 is configured to associate with events A3+A4, and the PSCell 2 is configured to associate with event A5. In this case, the PSCell 1 may be used as a candidate cell for CPA or a candidate cell for CPC for continuous CPAC evaluation; and the PSCell 2 may be used only as a candidate cell for CPC, and the configuration needs to be released after the UE completes CPAC.

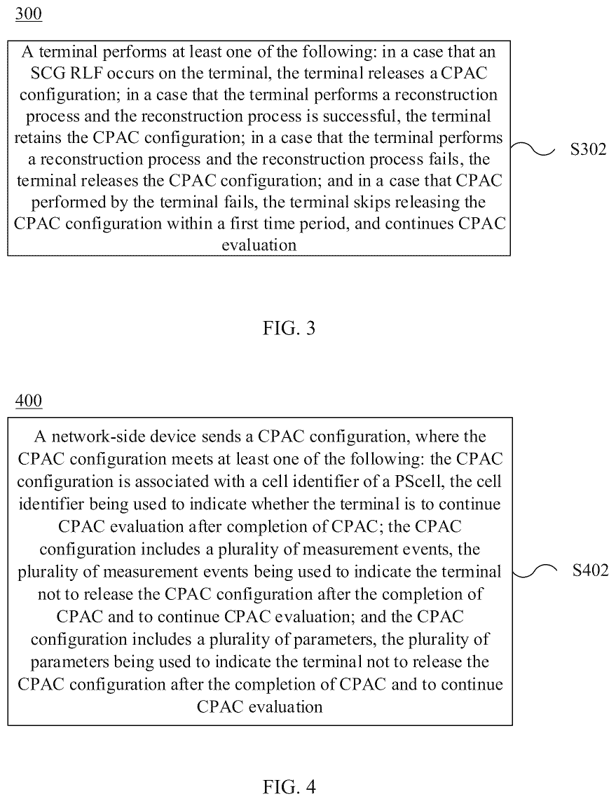

FIG. 3 is a schematic implementation flowchart of a processing method for CPAC configuration according to an embodiment of this application, and the method is applicable to a terminal. As shown in FIG. 3, the method 300 includes the following step:

S302: The terminal performs at least one of the following: in a case that an SCG RLF occurs on the terminal, the terminal releases a CPAC configuration; in a case that the terminal performs a reconstruction process and the reconstruction process is successful, the terminal retains the CPAC configuration; in a case that the terminal performs a reconstruction process and the reconstruction process fails, the terminal releases the CPAC configuration; and in a case that CPAC performed by the terminal fails, the terminal skips releasing the CPAC configuration within a first time period, and continues CPAC evaluation.

In the processing method for CPAC configuration in this embodiment of this application, the terminal may skip releasing the CPAC configuration, to reduce signaling required for the CPAC configuration, thereby reducing signaling overheads between the network-side device and the terminal; or the terminal may release the CPAC configuration, which is conducive to obtaining a new CPAC configuration, thereby avoiding communication problems caused by an improper previous CPAC configuration, and improving performance of the communication system.

In some implementations, in a case that the terminal performs a reconstruction process, the method further includes: if the terminal is restored to a previous first SCG cell, skipping releasing the CPAC configuration, and continuing CPAC evaluation; or if the terminal is restored to a new cell other than the first SCG cell or a new cell outside a preset range, releasing the CPAC configuration.

In some implementations, in a case that CPAC performed by the terminal fails, the method further includes: sending, by the terminal, CPAC failure information, where the CPAC failure information includes at least one of the following: identification information of a failed PSCell; and the number of CPAC attempts or failures.

FIG. 4 is a schematic implementation flowchart of a CPAC evaluation method according to an embodiment of this application, and the method is applicable to a network-side device. As shown in FIG. 4, the method 400 includes the following step:

S402: The network-side device sends a CPAC configuration, where the CPAC configuration meets at least one of the following: the CPAC configuration is associated with a cell identifier of a PScell, the cell identifier being used to indicate whether the terminal is to continue CPAC evaluation after completion of CPAC; the CPAC configuration includes a plurality of measurement events, the plurality of measurement events being used to indicate the terminal not to release the CPAC configuration after the completion of CPAC and to continue CPAC evaluation; and the CPAC configuration includes a plurality of parameters, the plurality of parameters being used to indicate the terminal not to release the CPAC configuration after the completion of CPAC and to continue CPAC evaluation.

In the CPAC evaluation method provided in this embodiment of this application, the terminal may skip releasing the CPAC configuration after the completion of CPAC, and continue CPAC evaluation, which can reduce signaling required for the CPAC configuration, thereby reducing signaling overheads between the network-side device and the terminal.

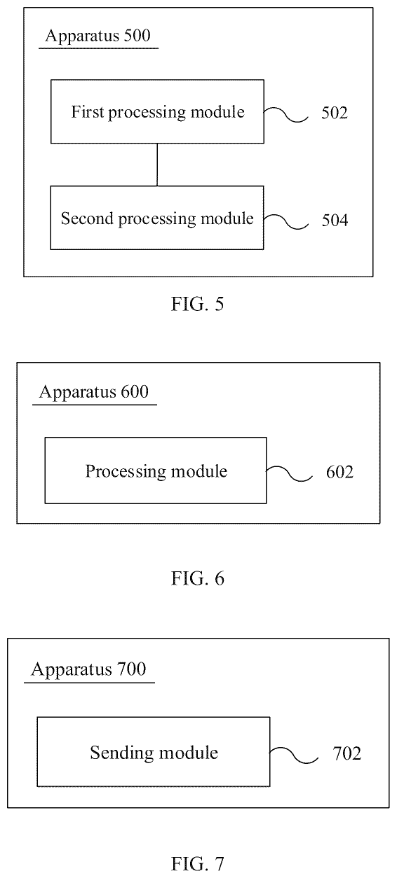

FIG. 5 is a schematic structural diagram of a CPAC evaluation apparatus according to an embodiment of this application. The apparatus may correspond to the terminal in other embodiments. As shown in FIG. 5, the apparatus 500 includes the following modules:
a first processing module 502, configured to perform CPAC; and
a second processing module 504, configured to skip releasing a CPAC configuration after the completion of CPAC, and continue CPAC evaluation.

The CPAC evaluation apparatus provided in this embodiment of this application may skip releasing the CPAC configuration after the completion of CPAC, and continue CPAC evaluation, which can reduce signaling required for the CPAC configuration, thereby reducing signaling overheads between the network-side device and the terminal.

In some implementations, the CPAC includes CPA and/or CPC. The second processing module 504 is configured to perform at least one of the following: (1) skipping releasing the CPAC configuration after completion of CPA, and continuing CPA evaluation; (2) skipping releasing the CPAC configuration after completion of CPA, and continuing CPC evaluation; (3) skipping releasing the CPAC configuration after completion of CPC, and continuing CPC evaluation; and (4) skipping releasing the CPAC configuration after completion of CPC, and continuing CPA evaluation.

In some implementations, the second processing module 504 is configured to skip releasing the CPAC configuration and continue CPAC evaluation after the completion of CPAC, in a case that at least one of the following is met: (1) the CPAC configuration is configured by an MN; (2) the apparatus and/or a network-side device operates on a target band; (3) the apparatus and/or the network-side device performs communication using a beam; (4) the number of times of CPAC performed by the apparatus within a preset time period meets a first preset condition; (5) the number of times of CPAC performed by the apparatus meets a second preset condition; (6) the apparatus supports being configured with a plurality of SCGs and/or PScells; (7) the network-side device indicates allowing the apparatus to perform continuous CPAC; (8) the apparatus has not received a new CPAC configuration; (9) a first timer has not expired, the first timer being used for indicating whether the apparatus is to release the CPAC configuration; (10) a count value of a first counter does not exceed a first threshold, the first counter being used for indicating whether the apparatus is to release the CPAC configuration; (11) after completion of the CPAC, cell identifiers of one or more added or changed PScells are equal to a first identifier; and (12) the apparatus has switched a PCell, and a cell identifier of a switched-to PCell is equal to a second identifier.

In some implementations, a CPAC configuration has been configured for the apparatus; and the second processing module 504 is further configured to perform at least one of the following: (1) in a case that an SCG RLF occurs on the apparatus, releasing the CPAC configuration; (2) in a case that the apparatus performs a reconstruction process and the reconstruction process is successful, continuing to retain the CPAC configuration; (3) in a case that the apparatus performs a reconstruction process and the reconstruction process fails, releasing the CPAC configuration; and (4) in a case that CPAC performed by the apparatus fails, skipping releasing the CPAC configuration within a first time period, and continuing CPAC evaluation.

In some implementations, the second processing module 504 is further configured to: in a case that a key of the MN is changed, release all CPAC configurations.

In some implementations, in a case that the second processing module 504 releases the CPAC configuration, the CPAC configuration released by the second processing module 504 includes at least one of the following: (1) all CPAC configurations configured for the apparatus; (2) a specific PCell-related CPAC configuration; (3) a specific PSCell-related CPAC configuration; (4) a CPAC configuration configured by a secondary node SN; and (5) a CPAC configuration determined by the SN and forwarded by the MN to the apparatus.

For the apparatus 500 in this embodiment of this application, refer to the processes of the method 200 in the corresponding embodiments of this application, and the units or modules of the apparatus 500 and other operations and/or functions described above are used to implement the corresponding processes in the method 200, with the same or equivalent technical effects achieved. For brevity, details are not repeated herein.

The CPAC evaluation apparatus in this embodiment of the application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal 11 listed above, and other devices may be a server, a Network Attached Storage (NAS), and the like. This is not limited in the embodiments of this application.

FIG. 6 is a schematic structural diagram of a CPAC configuration processing apparatus according to an embodiment of this application. The apparatus may correspond to the terminal in other embodiments. As shown in FIG. 6, the apparatus 600 includes the following module:
a processing module 602, configured to perform at least one of the following: in a case that an SCG RLF occurs on the apparatus, releasing a CPAC configuration; in a case that the apparatus performs a reconstruction process and the reconstruction process is successful, retaining the CPAC configuration; in a case that the apparatus performs a reconstruction process and the reconstruction process fails, releasing the CPAC configuration; and in a case that CPAC performed by the apparatus fails, skipping releasing the CPAC configuration within a first time period, and continuing CPAC evaluation.

The CPAC configuration processing apparatus in this embodiment of this application may skip releasing the CPAC configuration, to reduce signaling required for the CPAC configuration, thereby reducing signaling overheads between the network-side device and the terminal; or may release the CPAC configuration, which is conducive to obtaining a new CPAC configuration, thereby avoiding communication problems caused by an improper previous CPAC configuration, and improving performance of the communication system.

For the apparatus 600 in this embodiment of this application, refer to the processes of the method 300 in the corresponding embodiments of this application, and the units or modules of the apparatus 600 and other operations and/or functions described above are used to implement the corresponding processes in the method 300, with the same or equivalent technical effects achieved. For brevity, details are not repeated herein.

FIG. 7 is a schematic structural diagram of a CPAC evaluation apparatus according to an embodiment of this application. The apparatus may correspond to the network-side device in other embodiments. As shown in FIG. 7, the apparatus 700 includes the following module:
a sending module 702, configured to send a CPAC configuration, where the CPAC configuration meets at least one of the following: the CPAC configuration is associated with a cell identifier of a PScell, the cell identifier being used to indicate whether the terminal is to continue CPAC evaluation after completion of CPAC; the CPAC configuration includes a plurality of measurement events, the plurality of measurement events being used to indicate the terminal not to release the CPAC configuration after the completion of CPAC and to continue CPAC evaluation; and the CPAC configuration includes a plurality of parameters, the plurality of parameters being used to indicate the terminal not to release the CPAC configuration after the completion of CPAC and to continue CPAC evaluation.

In the CPAC evaluation method provided in this embodiment of this application, the terminal may skip releasing the CPAC configuration after the completion of CPAC, and continue CPAC evaluation, which can reduce signaling required for the CPAC configuration, thereby reducing signaling overheads between the network-side device and the terminal.

For the apparatus 700 in this embodiment of this application, refer to the processes of the method 400 in the corresponding embodiments of this application, and the units or modules of the apparatus 700 and other operations and/or functions described above are used to implement the corresponding processes in the method 400, with the same or equivalent technical effects achieved. For brevity, details are not repeated herein.

The CPAC evaluation apparatus provided in this embodiment of this application is capable of implementing the processes implemented in the method embodiments in FIG. 2 to FIG. 4, with the same technical effects achieved. To avoid repetition, details are not described herein again.

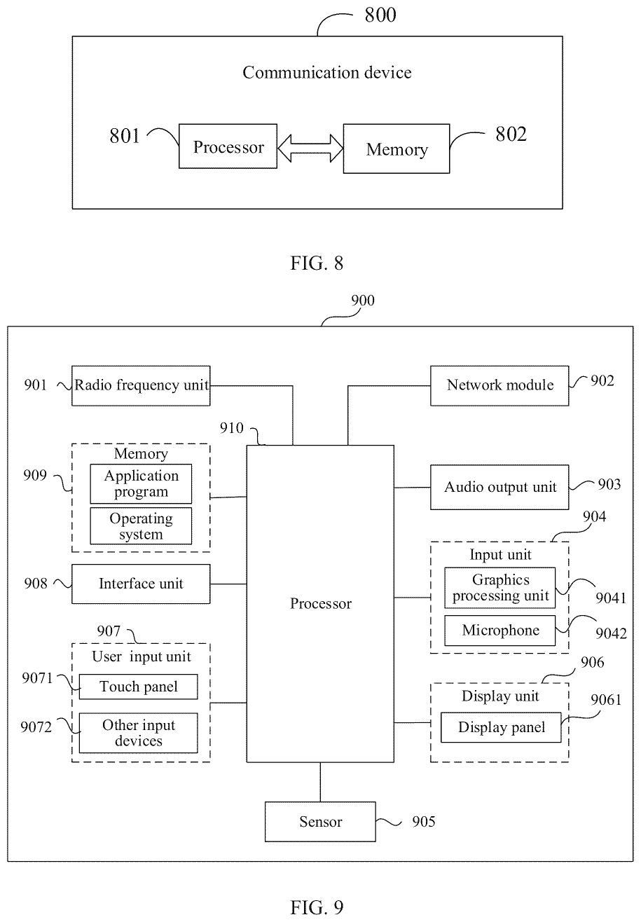

In some implementations, as shown in FIG. 8, an embodiment of this application further provides a communication device 800, including a processor 801, a memory 802, and a program or instructions stored in the memory 802 and capable of running on the processor 801. For example, when the communication device 800 is a terminal and when the program or the instructions are executed by the processor 801, the steps of the foregoing embodiments of the CPAC evaluation method and the processing method for CPAC configuration are implemented, with the same technical effects achieved. When the communications device 800 is a network-side device and when the program or the instructions are executed by the processor 801, the steps of the foregoing embodiments of the CPAC evaluation method are implemented, with the same technical effects achieved. To avoid repetition, details are not described herein again.

An embodiment of this application further provides a terminal, including a processor and a communication interface. The processor is configured to perform CPAC; and skip releasing a CPAC configuration after completion of CPAC, and continue CPAC evaluation; or the processor is configured to perform at least one of the following: release the CPAC configuration in a case that an SCG RLF occurs on the terminal; in a case that the terminal performs a reconstruction process and the reconstruction process is successful, retain the CPAC configuration; in a case that the terminal performs a reconstruction process and the reconstruction process fails, release the CPAC configuration; and in a case that CPAC performed by the terminal fails, skip releasing the CPAC configuration within a first time period and continue CPAC evaluation. The terminal embodiments correspond to the foregoing terminal-side method embodiments, and the implementation processes and implementations of the foregoing method embodiments can be applied to the terminal embodiments, with the same technical effects achieved. Specifically, FIG. 9 is a schematic diagram of a hardware structure of a terminal for implementing the embodiments of this application.

The terminal 900 includes but is not limited to at least part of components such as a radio frequency unit 901, a network module 902, an audio output unit 903, an input unit 904, a sensor 905, a display unit 906, a user input unit 907, an interface unit 908, a memory 909, and a processor 910.

Persons skilled in the art can understand that the terminal 900 may further include a power supply (for example, a battery) supplying power to the components, and the power supply may be logically connected to the processor 910 through a power management system. In this way, functions such as charge management, discharge management, and power consumption management are implemented by using the power management system. The structure of the terminal shown in FIG. 9 does not constitute any limitation on the terminal. The terminal may include more or fewer components than shown in the figure, or a combination of some components, or the components disposed differently. Details are not described herein again.

It can be understood that in this embodiment of this application, the input unit 904 may include a Graphics Processing Unit (GPU) 9041 and a microphone 9042. The graphics processing unit 9041 processes image data of a still picture or video obtained by an image capture apparatus (such as a camera) in a video capture mode or an image capture mode. The display unit 906 may include a display panel 9061, and the display panel 9061 may be configured in a form of a liquid crystal display, an organic light-emitting diode, and the like. The user input unit 907 may include at least one of a touch panel 9071 and other input devices 9072. The touch panel 9071 is also referred to as a touchscreen. The touch panel 9071 may include two parts: a touch detection apparatus and a touch controller. The other input devices 9072 may include but are not limited to a physical keyboard, a function key (such as a volume control key or a power on/off key), a trackball, a mouse, a joystick, and the like. Details are not described herein.

In this embodiment of this application, the radio frequency unit 901 receives downlink data from a network-side device, and then sends the downlink data to the processor 910 for processing. In addition, the radio frequency unit 901 may send uplink data to the network-side device. Generally, the radio frequency unit 901 includes but is not limited to an antenna, an amplifier, a transceiver, a coupler, a low noise amplifier, a duplexer, and the like.

The memory 909 may be configured to store software programs or instructions and various data. The memory 909 may include a first storage area for storing a program or instructions and a second storage area for storing data. The first storage area may store an operating system, an application program or instruction required by at least one function (for example, a sound playback function or an image playback function), and the like. In addition, the memory 909 may include a volatile memory or a non-volatile memory, or the memory 909 may include both a volatile memory and a non-volatile memory. The non-volatile memory may be a Read-Only Memory (ROM), a Programmable ROM (PROM), an Erasable PROM (EPROM), and an Electrically EPROM (EEPROM), or flash memory. The volatile memory can be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 909 in the embodiments of this application includes but is not limited to these and any other suitable types of memories.

The processor 910 may include one or more processing units. In some implementations, an application processor and a modem processor may be integrated in the processor 910. This application processor primarily processes operations involving an operating system, user interfaces, application programs, and the like. The modem processor primarily processes radio communication signals, for example, being a baseband processor. It can be understood that the modem processor may alternatively be not integrated in the processor 910.

The processor 910 may be configured to perform CPAC; and skip releasing a CPAC configuration after completion of CPAC, and continue CPAC evaluation; or the processor 910 may be configured to perform at least one of the following: release the CPAC configuration in a case that an SCG RLF occurs on the terminal; in a case that the terminal performs a reconstruction process and the reconstruction process is successful, retain the CPAC configuration; in a case that the terminal performs a reconstruction process and the reconstruction process fails, release the CPAC configuration; and in a case that CPAC performed by the terminal fails, skip releasing the CPAC configuration within a first time period and continue CPAC evaluation.

The terminal in this embodiment of this application may skip releasing the CPAC configuration after the completion of CPAC, and continues CPAC evaluation, which can reduce signaling required for the CPAC configuration, thereby reducing signaling overheads between the network-side device and the terminal. Alternatively, the terminal may release the CPAC configuration, which is conducive to obtaining a new CPAC configuration, thereby avoiding communication problems caused by an improper previous CPAC configuration, and improving performance of the communication system.

The terminal 900 provided in this embodiment of this application is capable of implementing the processes of the embodiments of the CPAC evaluation method and the processing method for CPAC configuration, with the same technical effects achieved. To avoid repetition, details are not described herein again.

An embodiment of this application further provides a network-side device, including a processor and a communication interface. The communication interface is configured to send a CPAC configuration, where the CPAC configuration meets at least one of the following: the CPAC configuration is associated with a cell identifier of a PScell, the cell identifier being used to indicate whether the terminal is to continue CPAC evaluation after completion of CPAC; the CPAC configuration includes a plurality of measurement events, the plurality of measurement events being used to indicate the terminal not to release the CPAC configuration after the completion of CPAC and to continue CPAC evaluation; and the CPAC configuration includes a plurality of parameters, the plurality of parameters being used to indicate the terminal not to release the CPAC configuration after the completion of CPAC and to continue CPAC evaluation. The network-side device embodiments correspond to the foregoing network-side device method embodiments, and the implementation processes and implementations of the foregoing method embodiments can be applied to the network-side device embodiments, with the same technical effects achieved.

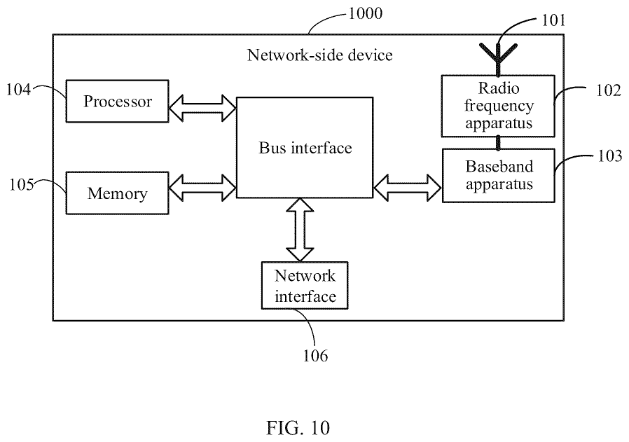

An embodiment of this application further provides a network-side device. As shown in FIG. 10, the network-side device 1000 includes an antenna 101, a radio frequency apparatus 102, a baseband apparatus 103, a processor 104, and a memory 105. The antenna 101 is connected to the radio frequency apparatus 102. In an uplink direction, the radio frequency apparatus 102 receives information by using the antenna 101, and sends the received information to the baseband apparatus 103 for processing. In a downlink direction, the baseband apparatus 103 processes to-be-sent information, and sends the information to the radio frequency apparatus 102; and the radio frequency apparatus 102 processes the received information and then sends the information out by using the antenna 101.

The method executed by the network-side device in the foregoing embodiments can be implemented in the baseband apparatus 103, and the baseband apparatus 103 includes a baseband processor.

The baseband apparatus 103 may include, for example, at least one baseband board, where a plurality of chips are disposed on the baseband board. As shown in FIG. 10, one of the chips is, for example, a baseband processor, and is connected to the memory 105 through the bus interface, to invoke a program in the memory 105 to perform the operations of the network device shown in the foregoing method embodiments.

The network-side device may further include a network interface 106, where the interface is, for example, a Common Public Radio Interface (CPRI).

The network-side device 1000 in this embodiment of this application further includes: instructions or a program stored in the memory 105 and capable of running on the processor 104. The processor 104 invokes the instructions or program in the memory 105 to execute the method executed by the modules shown in FIG. 7, with the same technical effects achieved. To avoid repetition, details are not described herein again.

An embodiment of this application further provides a readable storage medium, where a program or an instruction is stored in the readable storage medium. When the program or the instruction is executed by a processor, the processes of the foregoing embodiments of the CPAC evaluation method and the processing method for CPAC configuration can be implemented, with the same technical effects achieved. To avoid repetition, details are not described herein again.

The processor is a processor in the terminal described in the foregoing embodiments. The readable storage medium includes a computer-readable storage medium, for example, a computer read only memory ROM, a random access memory RAM, a magnetic disk, or an optical disc.

An embodiment of this application further provides a chip, where the chip includes a processor and a communications interface. The communications interface is coupled to the processor, and the processor is configured to run a program or instructions to implement the processes of the foregoing embodiments of the CPAC evaluation method and the processing method for CPAC configuration, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes of the foregoing embodiments of the CPAC evaluation method and the processing method for CPAC configuration, with the same technical effects achieved. To avoid repetition, details are not described herein again.

It should be noted that the processor may be at least one of a processor of the terminal, a processor of the network-side device and a processor of a cloud device.

An embodiment of this application further provides a CPAC evaluation system, including a terminal and a network-side device, where the terminal can be configured to execute the steps of the CPAC evaluation method described above, and the network-side device can be configured to execute the steps of the CPAC evaluation method described above.

It should be noted that in this specification, the term “include,” “comprise,” or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described method may be performed in an order different from the order described, and steps may be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. Certainly, the method in the foregoing embodiments may alternatively be implemented by hardware. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A Conditional Primary Secondary Cell Addition or Change (CPAC) evaluation method, performed by a terminal, comprising:
performing CPAC; and
skipping releasing a CPAC configuration after the completion of CPAC, and continuing CPAC evaluation.

2. The method according to claim 1, wherein the CPAC comprises Conditional Primary Secondary Cell Addition (CPA) or Conditional Primary Secondary Cell Change (CPC); and
the skipping releasing a CPAC configuration after the completion of CPAC, and continuing CPAC evaluation comprises at least one of the following:
skipping releasing the CPAC configuration after completion of CPA, and continuing CPA evaluation;
skipping releasing the CPAC configuration after completion of CPA, and continuing CPC evaluation;
skipping releasing the CPAC configuration after completion of CPC, and continuing the CPC evaluation; or
skipping releasing the CPAC configuration after completion of CPC, and continuing the CPA evaluation.

3. The method according to claim 1, wherein the skipping releasing a CPAC configuration after the completion of CPAC, and continuing CPAC evaluation comprises:
when at least one of the following is met, skipping releasing the CPAC configuration after the completion of CPAC, and continuing the CPAC evaluation:
the CPAC configuration is configured by a Master Node (MN);
the terminal or a network-side device operates on a target band;
the terminal or the network-side device performs communication using a beam;
the number of times of CPAC performed by the terminal within a preset time period meets a first preset condition;
the number of times of CPAC performed by the terminal meets a second preset condition;
the terminal supports being configured with a plurality of Secondary Cell Groups (SCGs) or Primary Secondary Cells (PScells);
the network-side device indicates allowing the terminal to perform continuous CPAC;
the terminal has not received a new CPAC configuration;
a first timer has not expired, the first timer being used for indicating whether the terminal is to release the CPAC configuration;
a count value of a first counter does not exceed a first threshold, the first counter being used for indicating whether the terminal is to release the CPAC configuration;
after completion of the CPAC, cell identifiers of one or more added or changed PScells are equal to a first identifier; or
the terminal has switched a Primary Cell (PCell), and a cell identifier of a switched-to PCell is equal to a second identifier.

4. The method according to claim 3, wherein when the network-side device indicates allowing the terminal to perform continuous CPAC, the method further comprises: receiving, by the terminal, first indication information, wherein the first indication information is used to indicate at least one of the following:
the terminal being allowed to perform continuous CPAC;
the number of times of CPAC;
duration of CPAC; or
an execution threshold, the execution threshold being used to indicate whether the terminal is to perform continuous CPAC.

5. The method according to claim 3, wherein that the network-side device indicates allowing the terminal to perform continuous CPAC comprises: allowing the terminal to perform continuous CPAC when at least one of the following is met:
a first PSCell configuration is associated with one or more measurement events;
the CPAC configuration comprises a parameter of the first timer, the first timer being used for indicating whether the terminal is to release the CPAC configuration; or
the CPAC configuration comprises a parameter of the first counter, the first counter being used for indicating whether the terminal is to release the CPAC configuration.

6. The method according to claim 5, wherein the measurement event comprises at least one of the following: A4 measurement event, B1 measurement event, A3 measurement event, A5 measurement event, or a predefined measurement event for continuous CPAC.

7. The method according to claim 3, wherein a starting or restarting moment of the first timer is related to at least one of the following moments:
a moment at which the CPAC configuration is received;
a moment at which CPAC is performed for the first time or any one time;
a moment at which CPAC is successfully completed for the first time or any one time; or
a moment at which CPAC fails for the first time or any one time.

8. The method according to claim 3, wherein the first timer is configured based on one of the following granularities:
per terminal, per PCell, per PSCell, or per Radio Resource Control (RRC) configuration message.

9. The method according to claim 8, wherein the first timer is configured based on the granularity of per PCell or per PSCell, and the starting or restarting moment of the first timer is related to at least one of the following moments:
a moment at which the CPAC configuration corresponding to the PCell or the PSCell is received;
a moment at which CPAC is performed for the PCell or the PSCell for the first time or any one time;
a moment at which CPAC for the PCell or the PSCell is completed for the first time or each time; or
a moment at which CPAC for the PCell or the PSCell fails for the first time or any one time.

10. The method according to claim 3, wherein the method further comprises: adding 1 to the count value of the first counter when at least one of the following is met:
CPAC is performed for one time;
CPAC is performed for one time and is successful; or
CPAC is performed for one time and fails.

11. The method according to claim 1, wherein a CPAC configuration has been configured for the terminal, and the method further comprises at least one of the following:
the terminal releases the CPAC configuration when a Secondary Cell Group (SCG) Radio Link Failure (RLF) occurs on the terminal;
when the terminal performs a reconstruction process and the reconstruction process is successful, the terminal continues to retain the CPAC configuration;
when the terminal performs a reconstruction process and the reconstruction process fails, the terminal releases the CPAC configuration; or
when CPAC performed by the terminal fails, the terminal skips releasing the CPAC configuration within a first time period and continues the CPAC evaluation.

12. The method according to claim 11, wherein when the terminal performs a reconstruction process, the method further comprises:
when the terminal is restored to a previous first SCG cell, skipping releasing the CPAC configuration, and continuing the CPAC evaluation; or
when the terminal is restored to a new cell other than the first SCG cell or a new cell outside a preset range, releasing the CPAC configuration.

13. The method according to claim 11, wherein when CPAC performed by the terminal fails, the method further comprises:
sending CPAC failure information, wherein the CPAC failure information comprises at least one of the following: identification information of a failed Primary Secondary Cell (PScell); or the number of CPAC attempts or failures.

14. The method according to claim 1, wherein the method further comprises: when a key of a Master Node (MN) is changed, releasing all CPAC configurations.

15. The method according to claim 1, wherein when the terminal releases the CPAC configuration, the CPAC configuration released by the terminal comprises at least one of the following:
all CPAC configurations configured for the terminal;
a specific Primary Cell (PCell)-related CPAC configuration;
a specific Primary Secondary Cell (PScell)-related CPAC configuration;
a CPAC configuration configured by a Secondary Node (SN); or
a CPAC configuration determined by the SN and forwarded by a Master Node (MN) to the terminal.

16. A processing method for Conditional Primary Secondary Cell Addition or Change (CPAC) configuration, performing by a terminal, comprising at least one of the following:
when a Secondary Cell Group (SCG) Radio Link Failure (RLF) occurs on the terminal, releasing a CPAC configuration;
when the terminal performs a reconstruction process and the reconstruction process is successful, retaining the CPAC configuration;
when the terminal performs a reconstruction process and the reconstruction process fails, releasing the CPAC configuration; or
when CPAC performed by the terminal fails, skipping releasing the CPAC configuration within a first time period, and continuing CPAC evaluation.

17. The method according to claim 16, wherein when the terminal performs a reconstruction process, the method further comprises:
when the terminal is restored to a previous first SCG cell, skipping releasing the CPAC configuration, and continuing the CPAC evaluation; or
when the terminal is restored to a new cell other than the first SCG cell or a new cell outside a preset range, releasing the CPAC configuration.

18. The method according to claim 16, wherein when CPAC performed by the terminal fails, the method further comprises:
sending CPAC failure information, wherein the CPAC failure information comprises at least one of the following: identification information of a failed Primary Secondary Cell (PScell); or the number of CPAC attempts or failures.

19. A Conditional Primary Secondary Cell Addition or Change (CPAC) evaluation method, performed by a network-side device, comprising:
sending, a CPAC configuration, wherein the CPAC configuration meets at least one of the following:
the CPAC configuration is associated with a cell identifier of a Primary Secondary Cell (PScell), the cell identifier being used to indicate whether the terminal is to continue CPAC evaluation after completion of CPAC;
the CPAC configuration comprises a plurality of measurement events, the plurality of measurement events being used to indicate the terminal not to release the CPAC configuration after the completion of CPAC and to continue CPAC evaluation; or
the CPAC configuration comprises a plurality of parameters, the plurality of parameters being used to indicate the terminal not to release the CPAC configuration after the completion of CPAC and to continue CPAC evaluation.

20. A terminal, comprising a processor and a memory, wherein a program or instructions capable of running on the processor are stored in the memory, and when the program or the instructions are executed by the processor, cause the processor to perform the method according to claim 1.
